(19) United States
(12) Patent Application Publication
(10) Pub. No.: US 2025/0199184 A1
(43) Pub. Date: Jun. 19, 2025

(54) GNSS SIGNAL SHARING SYSTEM FOR A VEHICLE

(71) Applicants: HYUNDAI MOTOR COMPANY, Seoul (KR); KIA CORPORATION, Seoul (KR)

(72) Inventor: Sang Heun Lee, Seoul (KR)

(73) Assignees: HYUNDAI MOTOR COMPANY, Seoul (KR); KIA CORPORATION, Seoul (KR)

(21) Appl. No.: 18/947,791

(22) Filed: Nov. 14, 2024

(30) Foreign Application Priority Data
Dec. 19, 2023 (KR) 10-2023-0185786

(51) Int. Cl. G01S 19/11

(52) U.S. Cl. CPC G01S 19/11

(57) ABSTRACT

A global navigation satellite system (GNSS) signal sharing system for a vehicle includes a GNSS antenna provided in the vehicle. The GNSS antenna is configured to receive a GNSS signal. The GNSS signal sharing system also includes a distributor configured to receive the GNSS signal from the GNSS antenna and to branch the GNSS signal. The GNSS signal sharing system additionally includes a plurality of GNSS receivers configured to receive the GNSS signal branched by the distributor. The GNSS antenna, the distributor, and a first GNSS receiver among the plurality of GNSS receivers, are included in an emergency call device. A second GNSS receiver among the plurality of GNSS receivers, is included in a device configured to use the GNSS signal, wherein the device configured to use the GNSS signal is provided in the vehicle.

### CROSS-REFERENCE TO RELATED APPLICATIONS

This application claims the benefit of and priority to Korean Patent Application Number 10-2023-0185786, filed Dec. 19, 2023, the disclosure of which is incorporated by reference herein in its entirety.

### TECHNICAL FIELD

The present disclosure relates to a global navigation satellite system (GNSS) signal sharing system for a vehicle. More particularly, the present disclosure relates to a system for sharing GNSS signals efficiently between devices using GNSS signals in vehicles.

### BACKGROUND

The content described in this section merely provides background information related to the present disclosure and does not necessarily constitute related art.

Recently, it has been found that an emergency call system (also known as an ‘eCall system’) in vehicles is of great help in saving lives in the event of a traffic accident. It has been mandatory to install an emergency call system in all types of passenger cars and light cargo vehicles, mainly, in the European Union (EU). An emergency call system is a device that, when installed in a vehicle, may automatically request rescue in the event of a traffic accident. Specifically, when a traffic accident is detected due to an airbag actuation, etc., the accident is automatically reported and traffic accident information including an accident location, a vehicle type, a driving direction, a fuel type, etc. is transmitted to the rescue center through a subscriber identification module (SIM) card installed in the vehicle.

The emergency call system receives location information through a global navigation satellite system (GNSS) antenna. The emergency call system is powered by a battery.

In addition, as technologies related to autonomous driving and an advanced driver assistance system (ADAS) have been on the rise, high-precision positioning technology for vehicles has been required. Accordingly, a GNSS receiver, one of the major sensor systems, plays an important role in determining an exact location of a vehicle by combining the inertial measurement unit (IMU), an inertial navigation system (INS), and real-time kinematic (RTK).

FIG. 4 shows a GNSS signal system for a vehicle according to the related art.

Referring to FIG. 4, the number of devices that use GNSS signals for precise positioning in a vehicle 1 has increased, and representative examples thereof include eCall systems, navigation systems, and autonomous driving controllers. Since these devices include GNSS antennas 11, 12, and 13 and GNSS receivers 21, 22, and 23, respectively, there is a problem of inefficiency, such as increased cost in building a GNSS signal system in a vehicle.

### SUMMARY

Embodiments of the present disclosure provide a design for efficiently distributing global navigation satellite system (GNSS) signals to devices that use GNSS signals in a vehicle.

In addition, embodiments of the present disclosure provide a GNSS signal sharing system for a vehicle that may reduce the number of antennas.

The problems to be solved by the present disclosure are not limited to the problems mentioned above. Other problems not mentioned herein may be clearly understood by those having ordinary skill in the art from the description below.

According to one aspect, a global navigation satellite system (GNSS) signal sharing system for a vehicle is provided. The GNSS signal sharing system includes a GNSS antenna provided in the vehicle. The GNSS antenna is configured to receive a GNSS signal. The GNSS signal sharing system also includes a distributor configured to i) receive the GNSS signal from the antenna and ii) branch the GNSS signal. The GNSS signal sharing system additionally includes a plurality of GNSS receivers configured to receive the GNSS signal branched by the distributor. The GNSS antenna, the distributor, and a first GNSS receiver among the plurality of GNSS receivers, are included in an emergency call device. A second GNSS receiver among the plurality of GNSS receivers, is included in a device configured to use the GNSS signal, wherein the device configured to use the GNSS signal is provided in the vehicle.

According to aspects of the present disclosure, a GNSS signal sharing system for a vehicle may efficiently transmit GNSS signals within an authentication range to several devices that use GNSS signals to precisely measure a location of the vehicle.

According to aspects of the present disclosure, a GNSS signal sharing system for a vehicle may reduce the number of GNSS antennas provided in the vehicle as compared to a system in which multiple devices that use GNSS signals within a vehicle include respective GNSS antennas.

The effects provided by embodiments of the present disclosure are not limited to the effects mentioned above. Other effects not mentioned herein may be clearly understood by those having ordinary skill in the art from the description below.

### BRIEF DESCRIPTION OF THE DRAWINGS

FIG. 1 is a block diagram of a GNSS signal sharing system for a vehicle, according to an embodiment of the present disclosure.

FIG. 2 is a block diagram of a GNSS signal sharing system for a vehicle, according to another embodiment of the present disclosure.

FIG. 3 is a block diagram of a GNSS signal sharing system for a vehicle, according to yet another embodiment of the present disclosure.

FIG. 4 illustrates a GNSS signal system for a vehicle according to the related art.

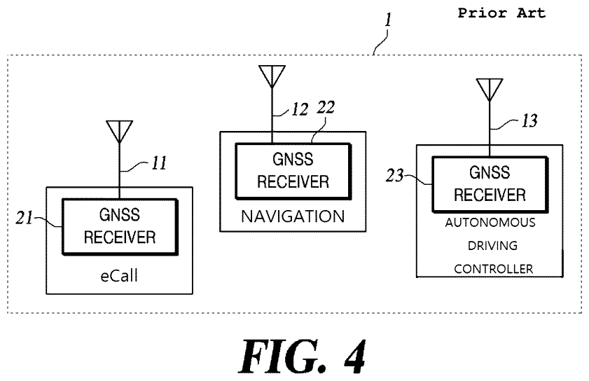

### DETAILED DESCRIPTION

Hereinafter, embodiments of the present disclosure are described in detail with reference to the accompanying drawings. In the accompanying drawings, like reference numerals designate like elements even when the elements are shown in different drawings. Further, in the following description, where it was determined that a specific description of a related known component or function may obscure the gist of the present disclosure, a detailed description thereof has been omitted for the purpose of clarity and for brevity.

Various ordinal numbers or alpha codes such as first, second, i), ii), a), b), etc., are prefixed solely to differentiate one component from the other but not to imply or suggest the substances, order, or sequence of the components. Throughout the specification, the terms “including” or “comprising”, or the like, are intended to specify the presence of the mentioned components, Such terms do not exclude presence or addition of other components unless specifically stated to the contrary.

The terms “ . . . unit,” “module,” “device,” “controller,” and the like in the specification refer to a unit that processes at least one function or operation, and may be implemented in hardware, software or a combination of hardware and software. The operations of the functions described in connection with the forms disclosed herein may be embodied directly in a hardware or a software module executed by a processor, or in a combination thereof.

When a component, device, element, or the like of the present disclosure is described as having a purpose or performing an operation, function, or the like, the component, device, or element should be considered herein as being “configured to” meet that purpose or perform that operation or function.

The description presented below in conjunction with the accompanying drawings is intended to describe embodiments of the present disclosure. The description is not intended to represent the only embodiments in which the technical idea of the present disclosure may be practiced.

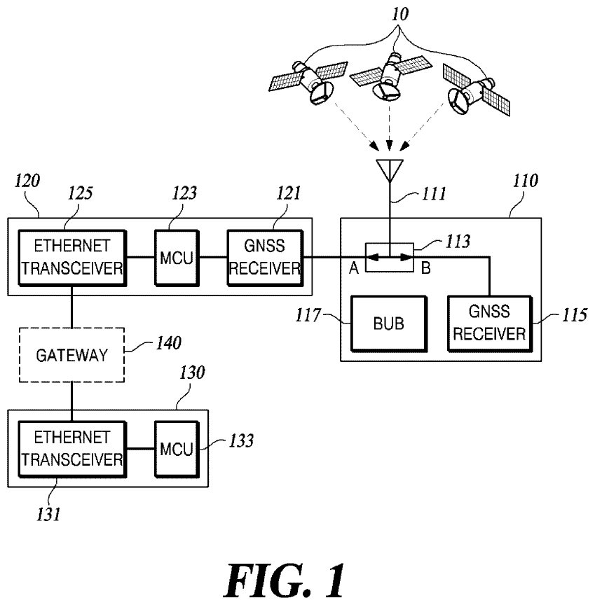

FIG. 1 is a block diagram of a global navigation satellite system (GNSS) signal sharing system for a vehicle, according to an embodiment of the present disclosure.

Referring to FIG. 1, a GNSS signal sharing system for a vehicle according to an embodiment of the present disclosure is a device that uses a global navigation satellite system (GNSS) signal within the vehicle. The GNSS signal sharing system includes an emergency call device 110, an autonomous driving control device 120, and a navigation device 130. The GNSS signal sharing system also includes a single GNSS antenna 111, a distributor 113, and a plurality of GNSS receivers 115 and 121. The single GNSS antenna 111, the distributor 113, and a first GNSS receiver 115, among the plurality of GNSS receivers 115 and 121, are included in the emergency call device 110 to satisfy an authentication range.

The emergency call device 110 is installed in the vehicle. When it is detected that an accident has occurred, the emergency call device 110 generates accident information including location information of the vehicle, reports the occurrence of the accident to an accident handling agency through a mobile communication network, and transmits the accident information. Here, the accident handling agency includes police stations, fire departments, hospitals, insurance companies, towing companies, and/or the like.

The emergency call device 110 may generate vehicle location information, which is an example of accident information, based on determining that an accident has occurred. In this case, the emergency call device 110 generates location information of the vehicle using GNSS signals.

Therefore, the emergency call device 110 does not always use GNSS signals while the vehicle is driving, but uses GNSS signals when an event occurs, i.e., when it is determined that an accident has occurred. However, in light of the important role that the emergency call device plays in reducing the extent of casualties in relation to accident handling, it is desirable for the emergency call device 110 to be configured to independently receive GNSS signals rather than receiving GNSS signals through another device.

In an embodiment, the emergency call device 110 includes the single GNSS antenna 111, the distributor 113, and the first GNSS receiver 115, and further includes a backup battery (BUB). In addition, although not shown in FIG. 1, the emergency call device 110 may further include a component that may process GNSS signals, may generate accident information including vehicle location information, and may transmit the generated accident information to the outside.

The GNSS signal sharing system for a vehicle according to an embodiment includes the single GNSS antenna 111. The single GNSS antenna 111 is configured to receive GNSS signals from a GNSS satellite 10. In an embodiment, the single GNSS antenna 111 is an antenna that has been evaluated as having high performance. This may ensure that multiple devices in the vehicle may use the signal received by the single GNSS antenna 111.

The distributor 113 includes an input terminal and a plurality of output terminals. The input terminal is connected to the GNSS antenna 111. The output terminals are connected to the plurality of GNSS receivers 115 and 121. The distributor 113 distributes the received GNSS signals to the first GNSS receiver 115 on a B side of the distributor 113 and a second GNSS receiver 121 on an A side of the distributor 113.

In an embodiment, the first GNSS receiver 115 is provided in the emergency call device 110, and the second GNSS receiver 121 is provided in the autonomous driving control device 120 described in more detail below. Thus, the distributor 113 transmits the received GNSS signals to the emergency call device 110 and the autonomous driving control device 120.

When distributing the GNSS signals, the distributor 113 may distribute the GNSS signals to the A and B sides at an equal power ratio. In another example, the ratio may be differentiated depending on functions of the devices that receive the GNSS signals (and usage conditions of the GNSS signals, etc.).

In an embodiment, the distributor 113 ensures that the strength of the GNSS signal transmitted to the first GNSS receiver 115 is less than or equal to the strength of the GNSS signal transmitted to the second GNSS receiver 121. This may reflect differences in the conditions and frequency of using GNSS signals in the operation of the emergency call device 110 and the autonomous driving control device 120.

In an embodiment, the emergency call device 110 is equipped with a spare power source for a backup battery (BUB). In an embodiment, because the emergency call device 110 has a built-in backup battery, even if the power supply from a main battery or auxiliary battery mounted on the vehicle is cut off in the event of a collision, GNSS signals may be processed with power from the backup battery. Thus, accident information may be transmitted to an accident handling agency.

The autonomous driving control device 120 may implement at least one advanced driver assistance system (ADAS) function. The ADAS may implement at least one of adaptive cruise control (ACC), autonomous emergency braking (AEB), forward collision warning (FCW), lane keeping assist (LKA), lane change assist (LCA), target following assist (TFA), blind spot detection (BSD), high beam assist (HBA), auto parking system (APS), PD collision warning system, traffic sign recognition (TSR), traffic sign assist (TSA), night vision (NV) system, driver status monitoring (DSM), and/or traffic jam assist (TJA).

The autonomous driving control device 120 generates location information indicating an absolute location of the vehicle based on a location signal received from the outside in order to implement at least one ADAS function. The location signal received from the outside may include a GNSS signal and/or a base station location signal received from a base station of a mobile communication network.

The autonomous driving control device 120 generates a driving route based on location information generated when a driver inputs a destination through a user interface. The generated driving route may include a driving map mapped to the generated location information.

As described above, the autonomous driving control device 120 may include the second GNSS receiver 121 that receives a GNSS signal. The second GNSS receiver 121 may transmit the GNSS signal received from the distributor 113 to at least one micro control unit (MCU) 123. The autonomous driving control device 120 includes at least one MCU that performs at least one ADAS function. The at least one MCU may be connected via a vehicle network. For example, the at least one MCU may be connected via a controller area network (CAN) bus. Although one MCU is shown in FIG. 1 for simplicity, the autonomous driving control device 120 may include a plurality of MCUs according to a function thereof.

The MCU 123 generates vehicle location information and/or driving map information using GNSS signals. Information generated by the MCU 123 may be transmitted to other devices. When such transmission is performed through an Ethernet connection, the autonomous driving control device 120 may further include an Ethernet transceiver 125. In the illustrated embodiment, the autonomous driving control device 120 transmits the generated information, such as vehicle location information and/or driving map information, to the navigation device 130 through an Ethernet connection.

The navigation device 130 is installed in the vehicle and provides a driving route for the vehicle based on the current location information of the vehicle and destination information set by the driver. The navigation device 130 may include an Ethernet transceiver 131 for receiving vehicle location information and/or driving map information through an Ethernet connection with the autonomous driving control device 120. The navigation device 130 may further include an MCU 133 for processing the received information and outputting the same. In addition, when the navigation device 130 transmits and receives information with the autonomous driving control device 120 through an Ethernet connection, the navigation device 130 may optionally further include a gateway 140.

In an embodiment, the GNSS signal sharing system for a vehicle includes the emergency call device 110, the autonomous driving control device 120, and the navigation device 130 as devices that use GNSS signals. This system is configured so that the single GNSS antenna 111 for receiving GNSS signals and the distributor 113 for distributing the GNSS signals to each of the above devices are included in the emergency call device 110. As a result, the emergency call device 110 is configured to receive GNSS signals independently without relying on other devices. The distributor 113 may be provided outside, and may branch the GNSS signal to each device. In another example, as illustrated in FIG. 1, the distributor 113 may be mounted inside the device. Mounting the distributor 113 inside the device may be advantageous in terms of cost. The GNSS signal sharing system is configured so that the GNSS signals received through the distributor 113 are provided to the emergency call device 110 and the autonomous driving control device 120, respectively.

In addition, the GNSS signal sharing system is configured so that the autonomous driving control device 120 and the navigation device 130 may communicate with each other. Accordingly, the navigation device does not need to directly receive GNSS signals, and the navigation device does not need to be separately equipped with a GNSS receiver. The number of GNSS receivers may be advantageously reduced in the vehicle overall. In addition, when the navigation device 130 receives location information and/or map information from the autonomous driving device 120, there is an advantage in avoiding duplication of processes for generating location and/or map information. The GNSS signal sharing system for a vehicle allows GNSS signals to be efficiently shared and utilized by devices that use GNSS signals within the vehicle.

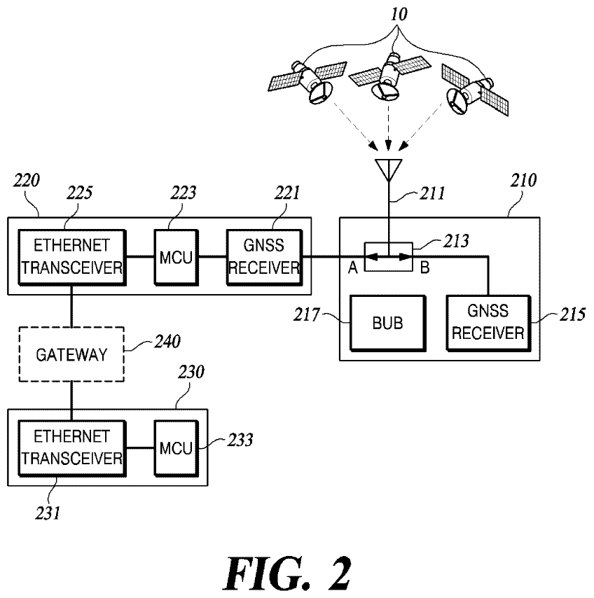

FIG. 2 is a block diagram of a GNSS signal sharing system for a vehicle, according to another embodiment of the present disclosure.

Referring to FIG. 2, the GNSS signal sharing system for a vehicle according to another embodiment of the present disclosure is a device that uses GNSS signals within a vehicle. The GNSS signal sharing system includes an emergency call device 210, a navigation device 220, and an autonomous driving control device 230. The GNSS signal sharing system includes a single GNSS antenna 211, a distributor 213, and a plurality of GNSS receivers 215 and 221. The single GNSS antenna 211, the distributor 213, and a first GNSS receiver 215, among the plurality of GNSS receivers 215 and 221, are included in the emergency call device 210 to satisfy an authentication range.

In the embodiment shown in FIG. 2, the emergency call device 210 is the same as the emergency call device 110 described above. Descriptions related to the emergency call device 110 may be equally applied to the emergency call device 210. The emergency call device 210 is configured to independently receive GNSS signals.

The emergency call device 210 includes the single GNSS antenna 211, the distributor 213, and the first GNSS receiver 215. The emergency call device 210 further includes a BUB 217.

The GNSS signal sharing system for a vehicle according to the embodiment illustrated in FIG. 2 includes the single GNSS antenna 211. The single GNSS antenna 211 is configured to receive GNSS signals from the GNSS satellite 10. In an embodiment, the single GNSS antenna 211 is an antenna that has been evaluated as having high performance. This is to ensure that multiple devices 210, 220, and 230 in the vehicle may use the signal received by the single GNSS antenna 211.

The distributor 213 includes an input terminal and a plurality of output terminals. The input terminal is connected to the GNSS antenna 211. The output terminals are connected to the plurality of GNSS receivers 215 and 221. The distributor 213 distributes the received GNSS signals to the first GNSS receiver 215 on the B side of the distributor 213 and a second GNSS receiver 221 on the A side of the distributor 213.

In the embodiment illustrated in FIG. 2, the first GNSS receiver 215 is provided in the emergency call device 210, and the second GNSS receiver 221 is provided in the navigation device 220 described in more detail below. The distributor 213 transmits the received GNSS signals to the emergency call device 210 and the navigation device 220.

When distributing the GNSS signals, the distributor 213 may distribute the GNSS signals to the A and B sides at an equal power ratio. In another example, the ratio may be differentiated depending on functions of the devices that receive the GNSS signals (and usage conditions of the GNSS signals, etc.).

In the embodiment illustrated in FIG. 2, the distributor 213 may ensure that the strength of the GNSS signal transmitted to the first GNSS receiver 215 is less than or equal to the strength of the GNSS signal transmitted to the second GNSS receiver 221. This may reflect differences in the conditions and frequency of using GNSS signals in the operation of the emergency call device 210 and the navigation device 220.

The navigation device 220 is installed in the vehicle and provides a driving route for the vehicle based on the current location information of the vehicle and destination information set by the driver.

As described above, the navigation system 220 may include the second GNSS receiver 221 that receives a GNSS signal. The second GNSS receiver 221 may transmit the GNSS signal received from the distributor 213 to an MCU 223. The MCU 223 may generate vehicle location information and/or driving map information using GNSS signals. Information generated by the MCU 223 may be transmitted to other devices. If such transmission performed through an Ethernet connection, the navigation device 220 may further include an Ethernet transceiver 225. In the illustrated embodiment, the navigation device 220 transmits the generated information, such as the vehicle location information and/or driving map information, to the autonomous driving control device 230 through an Ethernet connection.

The autonomous driving control device 230 may implement at least one ADAS function in the same manner as the autonomous driving control device 120 described above with reference to autonomous driving control device 130 of FIG. 1.

The autonomous driving control device 230 includes an Ethernet transceiver 231 for receiving vehicle location information and/or driving map information through an Ethernet connection with the navigation device 220. The autonomous driving control device 230 includes at least one MCU 233 that performs at least one ADAS function. The at least one MCU may be connected via a vehicle network. For example, at least one MCU may be connected via a CAN bus. In addition, when the autonomous driving control device 230 transmits and receives information with the navigation device 220 through an Ethernet connection, the autonomous driving control device 230 may optionally further include a gateway 240.

In the embodiment illustrated in FIG. 2, the GNSS signal sharing system for a vehicle is a device that uses GNSS signals and includes the emergency call device 210, the navigation device 220, and the autonomous driving control device 230. The GNSS signal sharing system is configured such that the single GNSS antenna 211 for receiving GNSS signals and the distributor 213 for distributing GNSS signals to each of the above devices are included in the emergency call device 210. As a result, the emergency call device 210 is configured to receive GNSS signals independently without relying on other devices. The distributor 213 may be provided outside, and may branch the GNSS signal to each device. In another example, as illustrated in FIG. 2, the distributor 213 to be mounted inside the device. Mounting the distributor 213 inside the device may be advantageous in terms of cost. The GNSS signal sharing system is configured so that the GNSS signals received through the distributor 213 are transmitted to the emergency call device 210 and the navigation device 220, respectively.

In addition, the GNSS signal sharing system is configured so that the navigation device 220 and the autonomous driving control device 230 are communicatively connected to each other. Accordingly, the autonomous driving control device does not need to directly receive GNSS signals, and the autonomous driving control device does not need to be equipped with a separate GNSS receiver. The number of GNSS receivers may be advantageously reduced in the vehicle overall. In addition, when the autonomous driving control device 230 receives location information and/or map information from the navigation device 220, there is an advantage in avoiding duplication of processes for generating location and/or map information. The GNSS signal sharing system for a vehicle allows GNSS signals to be efficiently shared and utilized by devices that use GNSS signals within the vehicle. However, when compared with the embodiment of FIG. 1, compared to the case in which the autonomous driving control device receives information from the navigation device as in the embodiment of FIG. 2, it may be superior in terms of information accuracy for the navigation device to receive the location information generated by the autonomous driving control device as in the embodiment of FIG. 1.

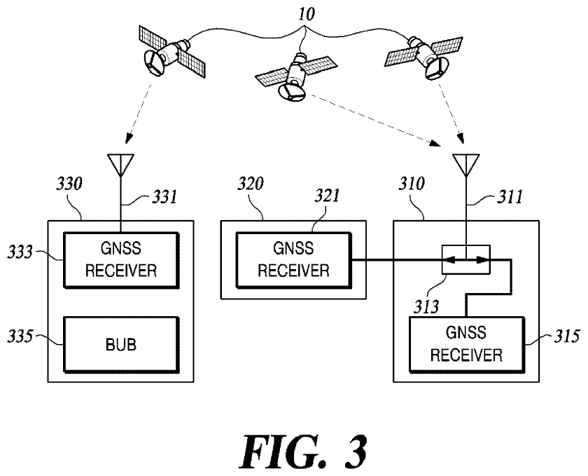

FIG. 3 is a block diagram of a GNSS signal sharing system for a vehicle, according to yet another embodiment of the present disclosure.

Referring to FIG. 3, a GNSS signal sharing system for a vehicle according to another embodiment of the present disclosure is a device that uses GNSS signals within a vehicle. The GNSS signal sharing system includes an autonomous driving device 310, a navigation device 320, and an emergency call device 330. The GNSS signal sharing system includes a plurality of GNSS antennas 311 and 331, a distributor 313, and a plurality of GNSS receivers 315, 321, and 333. A first GNSS antenna 311, among the plurality of GNSS antennas, the distributor 313, and a first GNSS receiver 315, among the plurality of GNSS receivers, are included in the autonomous driving control device 310. A second GNSS antenna 331, among the plurality of GNSS antennas, and a third GNSS receiver 333, among the plurality of GNSS receivers 315, 321, and 333, are included in the emergency call device 330 to satisfy an authentication range.

The GNSS signal sharing system for a vehicle according to the embodiment illustrated in FIG. 3 includes the plurality of GNSS antennas 311 and 331. Each of the GNSS antennas 311 and 331 is configured to receive a GNSS signal from the GNSS satellite 10. The first antenna 311 is included in the autonomous driving device 310. The second antenna 331 is included in the emergency call device 330. The first antenna 311 and the second antenna 331 may have different performances. The performance of the first antenna 311 may be higher than that of the second antenna 331. This may ensure that various devices in the vehicle may use the signal received by the first antenna 311.

The distributor 313 includes an input terminal and a plurality of output terminals. The input terminal is connected to the GNSS antenna 311. The output terminals are connected to the first GNSS receiver 315 and a second GNSS receiver 321 among the plurality of GNSS receivers. The distributor 313 distributes the received GNSS signals to the first GNSS receiver 315 and the second GNSS receiver 321.

In the embodiment illustrated in FIG. 3, the first GNSS receiver 315 is provided in the autonomous driving control device 310, and the second GNSS receiver 321 is provided in the navigation device 320 described in more detail below. The distributor 313 transmits the received GNSS signals to the autonomous driving control device 310 and the navigation device 320.

The distributor 313 may distribute the GNSS signals at an equal power ratio to both output terminals when distributing the GNSS signals. In another example, the ratio may be differentiated depending on functions of the devices that receive the GNSS signals (and usage conditions of the GNSS signals, etc.).

The emergency call device 330 includes the second GNSS antenna 331 and the third GNSS receiver 333. The emergency call device 330 further includes a BUB 335. In addition, although not shown in FIG. 3, the emergency call device 330 may further include a component may process GNSS signals, may generate accident information including vehicle location information, and may transmit the generated accident information to the outside.

It is advantageous for the emergency call device 330 to include a spare power source for the BUB. If the emergency call device 330 has a built-in backup battery, even if the power supply from a main battery or auxiliary battery mounted on the vehicle is cut off in the event of a collision, GNSS signals may be processed with power from the backup battery. Thus, vehicle accident information may be transmitted to an accident handling agency.

Like the aforementioned embodiments, the emergency call device 330 according to the embodiment of FIG. 3 is configured to receive GNSS signals independently without relying on other devices.

The autonomous driving control device 310 may implement at least one ADAS function. The autonomous driving control device 310 may generate location information indicating an absolute location of the vehicle based on a location signal received from the outside in order to implement at least one ADAS function. The location signal received from the outside may include a GNSS signal and/or a base station location signal received from a base station of a mobile communication network.

The autonomous driving control device 310 may generate a driving route based on the location information generated when the driver inputs a destination through a user interface. The generated driving route may include a driving map mapped to the generated location information.

In the autonomous driving control device 310, the first GNSS receiver 315 may transmit the GNSS signal received from the distributor 313 to at least one MCU. The autonomous driving control device 310 may include at least one MCU that performs at least one ADAS function. The at least one MCU may be connected via a vehicle network. For example, at least one MCU may be connected via a CAN bus. Although the MCU of the autonomous driving control device 310 is omitted in FIG. 3, the autonomous driving control device 310 may include a plurality of MCUs according to a function thereof.

The navigation device 320 is installed in the vehicle and provides a driving route for the vehicle based on the current location information of the vehicle and destination information set by the driver. In the navigation device 320, the second GNSS receiver 321 transmits the GNSS signal received from the distributor 313 to at least one MCU. Although the MCU of the navigation device 320 is omitted in FIG. 3, the navigation device 320 may include at least one MCU according to a function thereof.

In an embodiment, a GNSS signal sharing system for a vehicle is provided. The GNSS signal sharing system includes a GNSS antenna provided in the vehicle. The GNSS antenna is configured to receive GNSS signals. The GNSS signal sharing system also includes a distributor configured to i) receive the GNSS signals from the GNSS antenna and ii) branch the received GNSS signals. The GNSS signal sharing system additionally includes a plurality of GNSS receivers configured to receive the GNSS signals branched by the distributor. The GNSS antenna, the distributor, and the first GNSS receiver among the plurality of GNSS receivers, are included in an emergency call device. The second GNSS receiver among the plurality of GNSS receivers, is included in a device configured to use the GNSS signal, wherein the device configured to use the GNSS signal is provided in the vehicle.

In an embodiment, the device configured to use the GNSS signal includes an autonomous driving control device.

In an embodiment, the autonomous driving control device is configured to generate location information of the vehicle, the autonomous driving control device is also configured to transmit the generated location information to the navigation device.

In an embodiment, the autonomous driving control device is further configured to generate map information around the vehicle and transmit the generated map information to the navigation device.

In an embodiment, the device configured to use the GNSS signal includes a navigation device.

In an embodiment, the navigation device is configured to generate location information of the vehicle. The navigation device is also configured to transmit the generated location information to the autonomous driving control device.

In an embodiment, the strength of the GNSS signal transmitted by the distributor to the first GNSS receiver is less than or equal to the strength of the GNSS signal transmitted by the distributor to the second GNSS receiver.

In another embodiment, a GNSS signal sharing system for a vehicle is provided. The GNSS signal sharing system includes a plurality of antennas provided in the vehicle. The plurality of antennas, are configured to receive GNSS signals. The GNSS signal sharing system also includes a distributor configured to i) receive a GNSS signal from a first antenna among the plurality of antennas and ii) branch the GNSS signal. The GNSS signal sharing system additionally includes a plurality of GNSS receivers configured to receive the GNSS signal branched by the distributor. The first GNSS receiver, the distributor, and a first GNSS receiver among the plurality of GNSS receivers, are included in an autonomous driving control device. A second GNSS receiver among the plurality of GNSS receivers, is included in a navigation device. A second antenna, among the plurality of antennas, is included in an emergency call device.

In an embodiment, the performance of the first antenna is higher than the performance of the second antenna.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or a combination thereof. These various implementations may include those realized in one or more computer programs executable on a programmable system. The programmable system includes at least one programmable processor coupled to receive and transmit data and instructions from and to a storage system, at least one input device, and at least one output device. The programmable processor may be a special-purpose processor or a general-purpose processor. The computer programs (which are also known as programs, software, software applications, or code) contain instructions for a programmable processor and are stored in a “computer-readable recording medium.”

The computer-readable recording medium includes any type of recording device on which data that can be read by a computer system are recordable. Examples of non-transitory computer-readable recording mediums include non-volatile or non-transitory media such as a ROM, CD-ROM, magnetic tape, floppy disk, memory card, hard disk, optical/magnetic disk, storage devices, and the like. The computer-readable recording mediums may further include transitory media such as a data transmission medium. Further, the computer-readable recording medium can be distributed in computer systems connected via a network, wherein the computer-readable codes can be stored and executed in a distributed mode.

Various embodiments of the systems and techniques described herein may be implemented by a programmable computer. The computer may include a programmable processor, a data storage system (including volatile memory, non-volatile memory, or another type of storage system, or a combination thereof), and at least one communication interface. For example, the programmable computer may be one of a server, network device, set-top box, embedded device, computer expansion module, personal computer, laptop, personal data assistant (PDA), cloud computing system, or mobile device.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, the scope of the present disclosure is not to be limited by the above explicitly described embodiments. The scope of the present disclosure is defined by the appended claims and equivalents thereof.

What is claimed is:

1. A global navigation satellite system (GNSS) signal sharing system for a vehicle, the GNSS signal sharing system comprising:
a GNSS antenna provided in the vehicle, wherein the GNSS antenna is configured to receive a GNSS signal;
a distributor configured to i) receive the GNSS signal from the GNSS antenna and ii) branch the GNSS signal; and
a plurality of GNSS receivers configured to receive the GNSS signal branched by the distributor;
wherein
the GNSS antenna, the distributor, and a first GNSS receiver among the plurality of GNSS receivers, are included in an emergency call device, and
a second GNSS receiver among the plurality of GNSS receivers, is included in a device configured to use the GNSS signal, wherein the device configured to use the GNSS signal is provided in the vehicle.

2. The GNSS signal sharing system of claim 1, wherein the device configured to use the GNSS signal includes an autonomous driving control device.

3. The GNSS signal sharing system of claim 2, wherein the autonomous driving control device is configured to:
generate location information of the vehicle; and
transmit the location information to a navigation device.

4. The GNSS signal sharing system of claim 3, wherein the autonomous driving control device is further configured to:
generate map information around the vehicle; and
transmit the map information to the navigation device.

5. The GNSS signal sharing system of claim 1, wherein the device configured to use the GNSS signal includes a navigation device.

6. The GNSS signal sharing system of claim 5, wherein the navigation device is configured to:
generate location information of the vehicle; and
transmit the location information to an autonomous driving control device.

7. The GNSS signal sharing system of claim 1, wherein a strength of the GNSS signal transmitted by the distributor to the first GNSS receiver is less than or equal to a strength of the GNSS signal transmitted by the distributor to the second GNSS receiver.

8. A global navigation satellite system (GNSS) signal sharing system for a vehicle, the GNSS signal sharing system comprising:
a plurality of antennas provided in the vehicle, wherein the plurality of antennas are configured to receive GNSS signals;
a distributor configured to i) receive a GNSS signal from a first antenna among the plurality of antennas and ii) branch the GNSS signal; and
a plurality of GNSS receivers configured to receive the GNSS signal branched by the distributor;
wherein
the first antenna, the distributor, and a first GNSS receiver among the plurality of GNSS receivers, are included in an autonomous driving control device,
a second GNSS receiver among the plurality of GNSS receivers, is included in a navigation device, and
a second antenna among the plurality of antennas, is included in an emergency call device.

9. The GNSS signal sharing system of claim 8, wherein performance of the first antenna is higher than performance of the second antenna.
